(19) United States
(12) Patent Application Publication
(10) Pub. No.: US 2011/0137623 A1
(43) Pub. Date: Jun. 9, 2011

(54) Method for the numerical simulation of incompressible fluid flows

(75) Inventors: Thomas INDINGER, Herbertshausen (DE); Daniel GAUDLITZ, Muenchen (DE)

(73) Assignee: FLUIDYNA GMBH, GARCHING (DE)

(21) Appl. No.: 12/835,624

(22) Filed: Jul. 13, 2010

(30) Foreign Application Priority Data
Jul. 15, 2009 (DE) 102009033322.3

(51) Int. Cl. G06F 17/10; G06F 17/11

(52) U.S. Cl. 703/2

(57) ABSTRACT

The invention relates to a method for the numerical simulation of incompressible fluid flows which are described by a system of equations which comprises at least mass and pulse conservation equations for incompressible fluid flows from which, based on an algorithm (A), flow parameters are determined by means of a numeric projection method, wherein the algorithm (A) comprises at least three process steps (P1, P2, P3; P, E, K), and at least one process step (E) is parallelized, and the algorithm (A) comprises a predictor step (P) an evaluation step (E) and a corrector step (K). The invention is characterized in that the predictor step (P) is not parallelized or only slightly parallelized and is carried out at least on a first computing and control unit (RE1) and the evaluation step (E) is massively parallelized and is carried out on a plurality of second computing and control units (RE2.1, RE2.2, RE2.3, RE2.100).

The invention relates to a method for the simulation of incompressible fluid flows.

The application of the numerical simulation gains increasing importance in almost all application areas of mechanical engineering. The fluid flow simulation is used in the area of vehicle aerodynamics, aerodynamics of buildings, hydrodynamics or for fluid flows in process engineering. The simulation makes sense in the technical application only if it represents the actual fluid flow conditions accurately enough. Simulation methods are, depending on the complexity of the problems to be described, computationally very intensive, and, therefore, require a high computing power which is accompanied by a correspondingly high energy demand.

An improvement of the efficiency is achieved by parallel processing of the complete algorithm on a GPU—graphical processing unit. In principal, the application of computing units operating in parallel, for computing of algorithms structured in parallel, is known. Therein, an algorithm is sub-divided into partial processes of similar kind adapted to be processed in parallel. Each partial process is processed on a core of a GPU. This method is, for example, used in the Lattice-Boltzmann-method for fluid flows in the micro scale area.

A further example for this is disclosed in the paper “Navier-Stokes on Programmable Graphics Hardware using SMAC”—“Proceedings of XVII SIBGRAPI-II SIACG 2004. Pages 300-307. IEEE Press ISBN 0-7695-2227-0, Curitiba, Brazil, October 2004”. Therein, the complete algorithm is parallelized, and the individual parallel strings are massively processed in parallel exclusively on a GPU having a plurality of cores. Only administrative tasks during the computing procedure are not massively done in parallel in this case. This procedure has the deficiency that only a small number of problems can be solved in this way.

The invention is a method for the simulation of incompressible fluid flows in such a way that maximum accuracy is achieved with a time expenditure as low as possible and, in particular, a high energy efficiency.

The invention is based on the finding that the efficiency can be increased and that algorithms which are only adapted to be partially parallelized, are parallelized only at the decisive locations.

In a manner known per se, a method for the numerical simulation of incompressible fluid flows comprises an algorithm for solving a system of equations which comprises at least mass and pulse equations for incompressible fluid flows. The system of equations is solved by means of a numerical projection method. Furthermore, the algorithm comprises at least three processing steps wherein at least one processing step is parallelized. The algorithm comprises a predictor step, an evaluating step and a corrector step.

According to the invention, the algorithm is carried out in a distributed manner on at least a first and a plurality of second computing and control units. At least the predictor step is carried out on at least one first computing and control unit, wherein the predictor step is carried out not in parallel or only slightly in parallel.

Slightly parallel is delimited with respect to massive parallel, wherein massive parallel cannot be delimited just by a pure statement of the number of parallel partial processes. Rather, a process step can be massive parallel or can be processed massively in parallel, respectively, if only a small set of instructions specialized as required, is necessary for processing it, and this process step is carried out for a plurality of input parameters in parallel partial processes.

Besides the predictor step which is not parallelized or only slightly parallelized, at least a second massively parallelized evaluating step is carried out at least partly on at least one second massively parallel computing system wherein the computing system comprises a plurality of second computing and control units.

The first computing and control unit is structured such that different complex computing and system administration tasks can be executed. The second computing and control unit is structured such that a highly efficient parallel processing of partial processes of the same kind is possible by means of a plurality of second computing and control units. The second computing and control units process, in contrast to the first computing and control unit, a very much reduced set of instructions, but are, however, able to process simple tasks substantially faster.

The method of the invention has the advantage that the resources or architectures, respectively, of the computing and control units may be adjusted to the algorithm in an optimal way. Therefore, in particular with computationally intensive, parallelizable processing steps the computing efficiency is significantly improved although a complete parallelization of the complete algorithm is not necessary. In this way, computing and control units which are specially optimized for this purpose, can be used for executing partial processes. Thereby, most of all, second computing and control units having a higher energy efficiency can be used which means a better ratio of FLOPS (floating point operations per second)/Watt.

Thereby, energy is enormously saved in processing the algorithm according to the invention by a clever sub-division of the individual processing steps. Additionally, the required time for processing the algorithm is reduced as compared to the state of the art.

The method is particularly suited for the simulation of fluid flows in the macro scale area. The fluid flow status is essentially determined by the law of conservation of mass and pulse which is described by the Navier-Stokes-equations for incompressible fluid flows. The Navier-Stokes-equations are a known and reliable form of description for the operational laws of fluid flow mechanics. The Navier-Stokes-equations comprise the following terms: a time term, a pressure term, a convective term and source terms of arbitrary form.

By including the source term of arbitrary form into the system of equations in connection with the inventive processing method, it is now possible, contrary to the state of the art, to include a calculation of singularities and local source terms into the simulation in an efficient way.

Besides the equations for the conservation of mass and pulse, also equations of the conservation of energy and further equations which describe the problem of fluid flow, can also be included. This provides flexibility in the selection of the problems to be simulated.

Preferably, a simulation is effected over a previously defined fluid flow area and across a limited duration of time. The defined fluid flow area can be sub-divided into single partial fluid flow areas which are adapted to be evaluated one by one each. The partial fluid flow areas can be further sub-divided by special discretization methods.

For the numerical evaluation of the fluid flow parameters, a discretization of the space-time-continuum can be done. For the special discretization, the Finite-volume-method or the Finite-difference-method can be applied.

In particular the first computing and control unit can be formed as core of a CPU—central processing unit. As explained, the first computing and control unit executes the process which is not parallelized or only partly parallelized. The use of a core of a CPU as first computing and control unit provides the advantage that it is configured for the execution of differing, complex, not parallelized process steps.

In a further particularly advantages embodiment, the second computing and control unit is configured as a core of a GPU or GPGPU—general purpose graphical processing unit. This has the advantage that a modern GPU comprises, as a rule, a plurality of cores which are perfectly adapted for the parallel processing of similar partial processes. GPUs have a particularly good ratio between computing power and usage of electrical power. When using plural GPU cores, those may also he grouped. Since CPUs primarily are mounted on graphic cards, this implies that several graphic cards can be used in an advantage way in order to multiply the number of GPU cores which are available. In particular, the second computing and control unit can also be formed as a core of an accelerator.

Preferably, at least so many second computing and control units are available as parallel partial processes included in the second processing step are present at maximum. The number of the parallel partial processes depends on the number of the grid points to be calculated. Since the number of them is often considerable larger than the number of second computing and control units which are reasonably useable according to the present state of the development, the method is still not always executable in an optimal way at the present time. However, a maximum number of second computing and control units can always be used as far as it is economically reasonable. Therefore, in spite of the limited characteristics of the devices, a pronounced improvement over the state of the art is achieved.

In a particularly advantageous way, a projection method is used for the solution of the system of equations which method comprises the following processing steps. These are executed in the following order. First of all, a predictor step is executed, subsequently an evaluation step and, lastly, a corrector step is executed. In the corrector step, the results of the predictor step are corrected by the results of the evaluating step.

According to a further embodiment, the predictor step serves for determining a preliminary velocity field. The evaluation of the velocity field is based on the law of conservation of pulse. However, this takes place without consideration of the pressure term which is basically provided because of the law of conservation of pulse. Since the evaluation of the pressure term is neglected, the results of this step cannot be used as an overall result.

In the evaluating step, computation of the pressure field is effected considering the law of conservation of mass. The computing of the pressure field can be effected considering the discretized Poisson-equation. This (equation) can be solved particularly well by iterative methods. Preferably, resolving means are used which are effectively parallelizable. This step is computationally very intensive but can, however, be excellently parallelized because of the configuration of the resolving means.

For obtaining the numeric solution, the fluid flow area is discretized. For each grid point originating from the discretization, the solution of the Poisson-equation can be carried out in parallel. For the solution of the Poisson-equation, iterative processes are used which repeat the computing steps a plurality of times in order to obtain a result. The more often the iteration step is carried out, the more accurate the result will be. For the iterative solution methods envisioned here, the single computations of the grid points in each iteration step are independent of each other.

As a last step for computing the velocity field, a corrector step is carried out which corrects the preliminary velocity field by means of the pressure field. Thereby, a velocity field free of divergences is obtained which represents the result of the simulation.

According to the invention, the first process step in the sequence of the steps is carried out on the first computing and control unit, preferably a CPU core. The second process step in the sequence is carried out on a number of second computing and control units which depends on the number of grid points. The second computing and control units are, in particular, cores of a GPU or GPGPU. The last processing step can alternatively be carried out on the first or the second computing and control units.

The predictor step can contain computing steps which are not parallelized or only partly parallelized. The evaluating step, to the contrary, can be massively parallelized. According to the invention, the predictor step as well as the corrector step are correspondingly carried out on a first computing and control unit, whereas the parallel partial steps of the evaluating step are carried out on a large number of second computing and control units. By means of this possibility to parallelize, the execution of the parallel partial processes can be divided up among a plurality of second computing units whereby the computing power usable thereby, is considerably enlarged. A significant increase of the resolution results for the fluid flow area to be examined.

In order to be able to process a fluid flow area to be simulated, the fluid flow area can be sub-divided, depending on the number of the first computing and control units available, into partial fluid flow areas. In the ideal case, the sub-division is effected such that each partial fluid flow area comprises as many grid points formed by the special discrefization, as second control and computing units are available. Because of the high resolution of the fluid flow area, this objective can only be realized with an advanced technical development. With the hardware which is available at the moment, one can work only with fewer computing and control units as grid points are present, as already mentioned.

Furthermore, the fluid flow area can be implemented two-dimensionally or multi-dimensionally. Three-dimensional simulations result, in general, in a meaningful picture for most of the technical applications as compared to two-dimensional evaluations.

Further advantages, features and possibilities to use of the present invention can be taken from the following description in connection with the embodiments shown in the drawings.

The invention is described in more detail in the following with reference to the embodiments shown in the drawing.

In the specification, in the claims, in the abstract and in the drawings, the terms used in the list of reference signs below, and the corresponding reference signs are used. In the drawings:

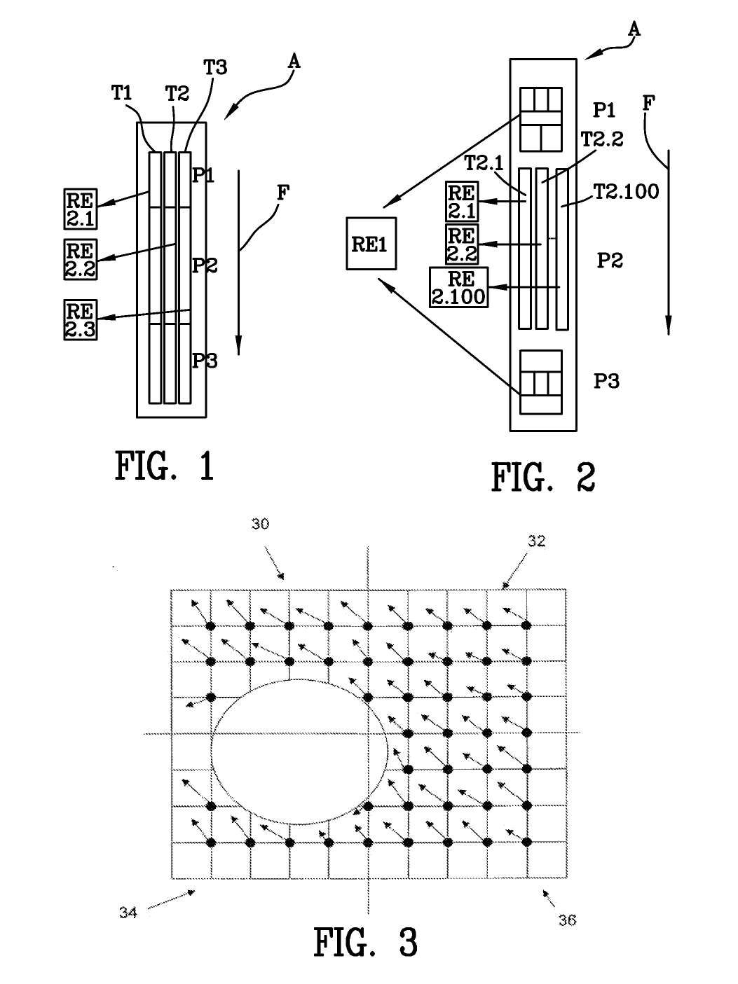

FIG. 1 represents a method for the parallelized process execution according to the state of the art;

FIG. 2 represents an inventive method for partially parallel processing of a simulation algorithm;

FIG. 3 represents a schematic velocity field of a fluid flow area around a body about which a flow is present; and

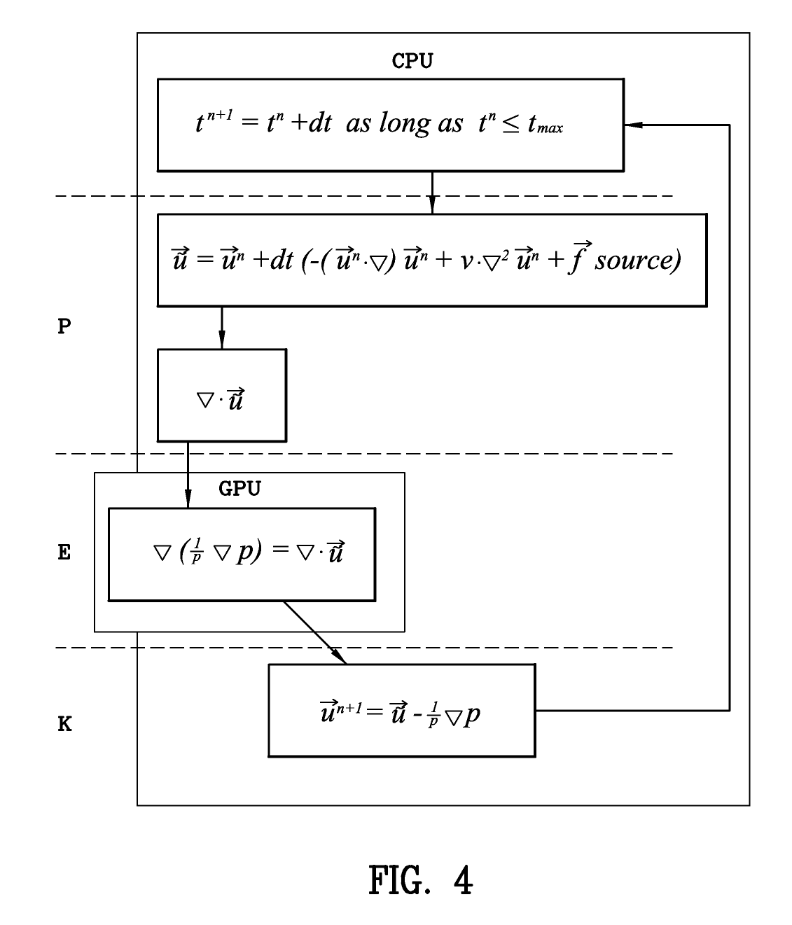

FIG. 4 represents a presentation of the method while using the Navier-Stokes-equations for incompressible fluid flows and by using CPU and CPU.

FIG. 1 shows the state of the art in which a parallelized algorithm A is part of parallel partial processes T1, T2, T3 is executed in the advancement direction F such that it is carried out on three second computing and control units RE2.1, RE2.2, RE2.3. This method has advantages over serial processing of the processing parts T1, T2, T3 in case an algorithm is completely, effectively parallelized.

However, the resources would not be optimally used when executing a further, not parallelized process step subsequently to the parallelized process step. In this case, only one of the three computing and control units would be used which, furthermore, is also not optimized in its configuration for such a usage.

FIG. 2 shows, as an example, a schematic sub-division of the execution of an algorithm A on different control and computing units. The execution of the algorithm A is carried out in the advancement direction F. The algorithm A comprises processing parts P1, P3 which are only partly or slightly parallelized, as well as a massively parallelized process step P2. The process step P2 is divided up into 100 parallelized partial processes T2.1, T2.2 to T2.100. For the execution of the process, a first computing and control unit RE1 and one hundred second computing and control units RE2.1, RE2.2 to RE2.100 are available. Out of the reasons of overview, not all processing parts and all related second computing and control units are shown. According to the invention, the processing steps P1, P3 which are not parallelized or only partly parallelized, are carried out on the first computing and control unit. The massively parallel partial processes T2.1, T2.2, T2.100 are each carried in parallel on the one hundred second computing and control units RE2.1, RE2.2 to RE2.100.

This gives the advantage that, by processing the massively parallelized processing part P2 by correspondingly many second computing and control units, the energy efficiency for the calculation is substantially higher as compared to a method according to the state of the art.

In FIG. 3, a velocity field \vec{u}ⁿ of a velocity area is shown at the point of time tⁿ where a circular body is surrounded by a fluid flow. In this figure, one sees the special discretization of the fluid flow area in the form of grid points shown schematically. Out of the reasons of overview, the space shown is two-dimensional in this case.

The grid points are also named supporting locations in the following.

The fluid flow area to be simulated is sub-divided into four partial areas 30, 32, 34, 36. The four partial areas 30, 32, 34, 36 are calculated in individual, parallel processes. In this case, a first computing and control unit and a number of second computing and control units are assigned to each of the partial areas 30, 32, 34, 36. A computing system reasonably comprises, in this case, a 4-core-CPU and 4 GPUs haven 240 cores each.

An additional possibility for improvement is shown here in that the inventive method itself is also parallelized. This results in a particularly effective evaluation.

In FIG. 4, the sequence of the method is shown by which a macroscopic incompressible fluid flow is described by means of corresponding Navier-Stokes-equations for incompressible fluid flows.

The Algorithm A consists out of a predictor step P, an evaluation step E and a corrector step K. The predictor and corrector steps P, K are, in contrast to the evaluating step E, not massively parallelized. The execution is carried out on a computer based system which comprises a CPU—central processing unit—as well as four GPUs—graphical processing units—, wherein the CPU comprises four cores and is configured for the execution of partial processes which are not parallelized or slightly parallelized. The GPU comprises 240 cores, where a parallel partial process may be executed by each core.

The simulation represents the velocity field \vec{u} of a defined fluid flow area over a selected time space. The problem for incompressible fluid flows lies in the coupling of the laws for the conservation of pulse and mass. This is solved by means of the Helmholtz-subdivision of the velocity field. The velocity field is composed out of a source free portion and an irrotational portion, and can, accordingly, also be divided up into both of these portions.

The Navier-Stokes equations for incompressible fluid flows read:

### Conservation of Mass:

∇·\vec{u}=0

### Conservation of Pulse:

$$\frac{δ \vec{u}}{δ t} + ( \vec{u} \cdot ∇ ) \vec{u} = - ( \frac{1}{ρ} ) ∇ p + v \cdot {∇}^{2} \vec{u} + {\vec{f}}_{Source}$$

Course of the discretization of the partial differential equation system, the sub-division of the space-time-continuum into single grid points in space and a sub-division of the time span into time steps with variable size dt is resulting.

The solution of the discretized equation system is carried out with the aid of the projection method. Therefore, the algorithm comprises a predictor step P, an evaluation step E and a corrector step K.

The algorithm is traversed once for each time step dt until the defined time space has been reproduced. This corresponds to a loop with tⁿ⁺¹=tⁿ+dt solange tⁿ≦tₘₐₓ.

First of all, a preliminary velocity field {tilde over (\vec{u} is derived from the law of conservation of pulse in the predictor step P. In the calculation of the preliminary velocity field {tilde over (\vec{u}, the pressure term −(1/ρ)∇p which is basically provided for the conservation of pulse, is neglected. Therefore, it follows for the calculation of the preliminary velocity field: {tilde over (\vec{u}=\vec{u}+dt(−(\vec{u}^{h}·∇)\vec{u}^{u}+ν·∇²\vec{u}^{u}+\vec{f}_{Source})

Since the source terms have already been taken into account in the predictor step, they also are not included in the Poisson-pressure-equation. For this calculation, the simplified pulse equations for incompressible fluid flows are integrated over the time step. This integration is effected for all grid points of the CPU.

Subsequently, the divergence ∇·{tilde over (\vec{u} of the preliminary velocity field {tilde over (\vec{u} is calculated.

The conservation of mass, i.e. the lack of divergence ∇·\vec{u}=0 of the velocity field, can be considered as a side condition for the calculation of the velocity field \vec{u}. This side condition is considered in that the pressure field p is calculated considering the divergence of the preliminary velocity field ∇·\vec{u} in a second step, the evaluating step E. The pressure field p is evaluated with the aid of the discretized Poisson-equation ∇(1/ρ∇p)=∇·{tilde over (\vec{u}.

A considerable portion of the computational effort of the simulation is taken up by the iterative solution of the Poisson-equation of the pressure field. Consequently, the number of supporting positions would have to be restricted in a serial processing which would have the result of a course and imprecise representation of the fluid flow. The calculation of the Poisson-equation can require up to about 80% to 90% of the computational power of the complete process. A particularly efficient usage of the computational power is enabled by a massively parallel execution of the process step on the GPUs. For solving this equation, for example the class of the conjugated gradient methods is used which can be effectively parallelized. According to the invention, in each iteration step all grid points are calculated independent from each other and in parallel by means of the multiple number of cores of the GPUs operating in parallel.

After the pressure field of the fluid flow has been evaluated in this way, this result is used in a third process step, the corrector step K, for the purpose of correcting the preliminary velocity field with the results of the pressure field in order to obtain the velocity field \vec{u}ⁿ⁺¹={tilde over (\vec{u}−1/ρ∇p being free of divergence. This computing step has to be carried out also for each grid point, requires, however, only a small computing power and is, therefore, carried out on the CPU. This approach results in an additional simplification in the implementation.

The algorithm is repeated until the total desired time span is reproduced.

In this way, an incompressible fluid flow is very exactly reproduced in a very efficient way. With these data, the characteristics of devices which are loaded by fluid flow can be evaluated which again leads to significant improvement of the properties of fluid dynamic devices. This can be achieved without carrying out elaborate experimental analysis. For example, energy can enormously be saved with transportation means because of the reduction of their cw-value.

### LIST OF REFERENCE SIGNS

A algorithm
P predictor step
E evaluation step
K corrector step
F advancement direction
P1 process step
P2 process step
P3 process step
T1 parallel partial process
T2 parallel partial process
T3 parallel partial process
RE1 first computing and control unit
RE2.1 second computing and control unit
RE2.2 second computing and control unit
RE2.3 second computing and control unit
RE2.100 second computing and control unit
30 partial area
32 partial area
34 partial area
36 partial area

The invention has been set forth by way of example only and those skilled in the art will readily recognize that changes may be made to the examples without departing from the spirit and scope of the claimed invention.

1. Method for the numerical simulation of incompressible fluid flows which are described by a system of equations which comprises at least mass and pulse conservation equations for incompressible fluid flows from which, based on an algorithm (A), flow parameters are determined by means of a numeric projection method, wherein the algorithm (A) comprises at least three process steps (P1, P2, P3; P, E, K), and at least one process step (E) is parallelized, and the algorithm (A) comprises a predictor step (P) an evaluation step (E) and a corrector step (K) characterized in that the predictor step (P) is not parallelized or only slightly parallelized and is carried out at least on a first computing- and control unit (RE1) and the evaluation step (E) is massively parallelized and is carried out on a plurality of second computing- and control units (RE2.1, RE2.2, RE2.3, RE2.100).

2. Method according to claim 1 characterized by a macrofluidic consideration.

3. Method according to one of the proceeding claims, characterized in that the mass and pulse conservation equations are based on Navier-Stokes-equations for incompressible fluid flows, and that the pulse conservation equations comprise a pressure term, a source term, a convective term and a time term.

4. Method according to one of the proceeding claims, characterized in that the system of equations comprises an equation for energy conservation.

5. Method according to one of the proceeding claims, characterized in that the simulation is effected across a defined area and cross a defined duration.

6. Method according to one of the proceeding claims, characterized in that the space-time-continuum is discretized.

7. Method according to one of the proceeding claims, characterized in that a spatial discretization is carried out by means of a finite-volume-method or a finite-difference-method.

8. Method according to one of the proceeding claims, characterized in that a first computing- and control unit (RE1) is a processor core of a CPU.

9. Method according to one of the proceeding claims, characterized in that a second computing- and control unit (RE2.1, RE2.2, RE2.3, RE2.100) is a processor core of a GPU.

10. Method according to one of the proceeding claims, characterized in that a second computing- and control unit (RE2.1, RE2.2, RE2.3, RE2.100) is a processor core of an accelerator.

11. Method according to one of the proceeding claims, characterized in that the defined area is sub-divided into several partial areas (30, 32, 34, 36).

12. Method according to one of the proceeding claims, characterized in that the algorithm (A) comprises three process steps which are traversed in the following order:
predictor step (P)
evaluation step (E)
corrector step (K)

13. Method according to one of the proceeding claims, characterized in that, in the corrector step (K), the results of the predictor step (P) are corrected by means of the results of the evaluation step (E).

14. Method according to one of the proceeding claims, characterized in that, in the predictor step (P), a preliminary velocity field across a defined area is calculated based on the law of pulse conservation by means of convective terms, source terms and the time term.

15. Method according to one of the claims 12 to 14, characterized in that, in the evaluation step (E), a pressure field is determined on the basis of the equation of mass conservation.

16. Method according to one of the claims 12 to 15, characterized in that, in the corrector step, the preliminary velocity field is corrected with the pressure field into a velocity field free of divergence.

17. Method according to claim 16, characterized in that the determination of the pressure field is effected by means of discretized Poisson-equations.

18. Method according to claim 17, characterized in that the predictor step (P) is carried out on at least one first computing- and control unit (RE1), the evaluation step (E) is carried out on at least one second computing- and control unit (RE2.1, RE2.2, RE2.3, RE2.100), and the corrector step (K) is carried out on a second computing- and control unit (RE2.1, RE2.2, RE2.3, RE2.100).

19. Method according to one of the claims 19 to 21, characterized in that the predictor step (P), the evaluation step (E) and the corrector step (K) are carried out for each time step at least once.

20. Method according to one of the claims 18 to 22, characterized in that an iterative method is used for solving the discrete Poisson-equation.
